(19) United States
(12) Patent Application Publication
(10) Pub. No.: US 2022/0072477 A1
(43) Pub. Date: Mar. 10, 2022

(54) METHOD FOR TREATING WHEY DEMINERALIZATION EFFLUENTS

(71) Applicant: SYNUTRA FRANCE INTERNATIONAL, CARHAIX-PLOUGUER (FR)

(72) Inventor: Michel CHAVERON, LA TOUR DE PEILZ (CH)

(73) Assignee: SYNUTRA FRANCE INTERNATIONAL, CARHAIX-PLOUGUER (FR)

(21) Appl. No.: 17/283,363

(22) PCT Filed: Oct. 9, 2019
(86) PCT No.: PCT/FR2019/052384

§ 371 Date: Apr. 7, 2021

(30) Foreign Application Priority Data
Oct. 9, 2018 (FR) 18 59360

(51) Int. Cl. B01D 61/58; A23C 9/144; A23C 21/00; B01D 61/02; B01D 61/44; B01D 61/08; B01D 61/46; C02F 9/00

(52) U.S. Cl. CPC B01D 61/58; C02F 1/441; A23C 21/00; B01D 61/025; B01D 61/027; B01D 61/445; B01D 61/022; B01D 61/08; B01D 61/46; C02F 9/00; B01D 2311/18; B01D 2311/08; B01D 2317/022; B01D 2317/025; B01D 2317/08; A23C 9/144

(57) ABSTRACT

A treatment of demineralization effluents, particularly recycling effluents, a method for demineralizing whey and treating the effluents, and a facility for implementation thereof. The treatment of whey demineralization effluents includes: i) supplying a whey demineralization effluent, ii) treating by reverse osmosis effluent recovered in i) to obtain a reverse osmosis permeate and retentate, iii) neutralizing the retentate pH, iv) treating the neutralized retentate by nanofiltration to obtain a permeate including monovalent ions and a retentate including divalent ions and residual organic materials, v) treating the permeate in iv) by electrodialysis with bipolar membrane to obtain acidic solution(s) and basic solution(s). Thus, it is possible to treat effluents, limit their environmental impact, generate solutions for the whey demineralization process, reduce the cost of whey demineralization because some process water from electrodialysis comes from treatment of the generated effluents, and reduce the total amount of effluent sent to the wastewater treatment plant.

The present invention relates to the field of the treatment of demineralization effluents, more particularly to the recycling of such effluents, and concerns a method for demineralizing whey and for treating the effluents produced, as well as a facility suitable for implementing the method.

Whey is the liquid resulting from the coagulation of milk, said coagulation being caused by the denaturation of casein, the major protein in milk. There are two types of coagulation, each leading to two different types of whey. Indeed, depending on whether the coagulation is lactic coagulation or rennet coagulation, the whey obtained is respectively referred to as acid whey or as sweet whey. Whey is also called cheese whey or cheese byproduct.

Whey valorization has long represented both economic and ecological issues. Indeed, although its composition is attractive, whey has a Chemical Oxygen Demand (COD) of 50 g/L to 70 g/L, which makes it a polluting organic product that cannot be released into the environment and that is expensive to transport because of its highly diluted nature (dry extract 5 to 6%).

This is why valorization pathways have emerged over time, in particular by means of demineralization processes which make it possible to obtain demineralized whey.

Demineralized whey, liquid or powder, is nowadays the main component of infant and dietetic products, in particular milk substitutes for breast milk. Demineralized whey also has other applications, for example as a replacement ingredient for skim milk in candy-chocolate production or in the manufacture of reconstituted milk.

Different techniques can be considered for whey demineralization, in particular ultrafiltration, reverse osmosis, nanofiltration, electrodialysis, and ion exchange. As the first three techniques are far too specific, only the last two have found real applications on an industrial scale. The most effective methods for whey demineralization today thus involve electrodialysis and ion exchange, which are applied separately or in combination.

Electrodialysis is an electrochemical technique which makes it possible to selectively remove ionized salts from a solution, by migration under the influence of an electric field through membranes selectively permeable to cations and anions. According to this technique, the ionized salts in solution in the whey migrate under the effect of an electric field through membranes selectively permeable to cations and anions, and are eliminated in the form of demineralization effluents or brines.

Ion exchange is a technique based on the principle of ionic equilibria existing between a solid phase and a liquid phase, and involves absorption and exclusion phenomena. Thus, according to this technique, the ionic equilibrium between a resin as the solid phase and the whey to be demineralized as the liquid phase is used, the ions being absorbed on resin of the same nature during the saturation phase, and the resins are then regenerated.

However, on an industrial scale, whey demineralization methods generate very large amounts of effluents, and in particular saline effluents.

Management of these effluents poses a problem of crucial importance in a context of reducing the impact of processes on the environment. This liquid waste, which belongs to the category of Special Industrial Waste (SIW), presents treatment difficulties which have led manufacturers to resort in particular to external companies specializing in the management of this type of waste.

This practice has some advantages, but does pose some problems. Beyond the purely economic aspect linked to the treatment cost, the storage and transport of these effluents pose a significant risk for the environment. In addition, treatment offsite from the production site prohibits any recycling.

In addition, the presence of salts considerably reduces the effectiveness of treatments implemented to allow discharging these demineralization effluents into the outdoor environment, for example such as biological or physicochemical treatments.

Another solution implemented by manufacturers is to send effluents to the waste treatment plant. However, this practice also poses cost concerns and environmental concerns.

There is therefore a need to develop methods which allow treating all or part of the demineralization effluents, in order to limit the environmental impact as well as reduce the risks and costs associated with the transport and storage of these effluents.

The aim of the present invention is therefore to provide a method which allows treating demineralization effluents in order to reduce their environmental impact. Advantageously, this treatment can make it possible to recycle part of the brine and thus leads to a reduction in the operating cost of whey demineralization methods.

It is to the Applicant's credit to have discovered that this aim could be achieved by means of a specific treatment method which can be directly implemented at the industrial whey demineralization site.

A first object of the invention relates to a method for treating whey demineralization effluents.

An object of the invention is therefore a method for treating whey demineralization effluents, comprising the following steps:
i. supplying a whey demineralization effluent,
ii. treating by reverse osmosis the effluent recovered in step i) so as to obtain a reverse osmosis permeate and retentate,
iii. neutralizing the reverse osmosis retentate to a pH of between 6 and 9,
iv. treating the neutralized reverse osmosis retentate by nanofiltration so as to obtain a nanofiltration permeate mainly comprising the monovalent ions and a nanofiltration retentate mainly comprising the divalent ions,
v. treating the nanofiltration permeate obtained in step iv) by electrodialysis with bipolar membrane, so as to separate out at least one acidic solution and at least one basic solution.

The first step of the method therefore consists of a step i) of supplying a whey demineralization effluent.

For the purposes of the invention, the term “demineralization effluents” means the liquid residues obtained during the demineralization of whey, other than the demineralized whey. It can thus be effluents resulting from the demineralization of whey by electrodialysis and/or by ion exchange.

According to one particular embodiment, these are effluents resulting from the demineralization of whey by electrodialysis, said effluents also being known as brine.

Step ii) of the method according to the invention consists of treating by reverse osmosis the effluents supplied in step i) so as to obtain a reverse osmosis permeate and retentate.

Reverse osmosis is a process known to those skilled in the art, allowing separation in the liquid phase by permeation through semi-selective membranes under the effect of a pressure gradient. The flow takes place continuously, tangentially to the membrane. A portion of the effluents to be treated is divided at the membrane into two parts of different concentrations: the permeate, which passes through the membrane, and the retentate, which does not pass through and which contains the molecules or particles retained by the membrane.

Step ii) of the method according to the invention thus makes it possible to concentrate the effluent from whey demineralization via the production of a retentate on the one hand and of a permeate on the other hand.

The reverse osmosis step can be carried out until a concentration factor (CF) of 3 to 5 in the retentate is obtained. Preferably, the reverse osmosis can be carried out until a CF in the retentate approximately equal to 4 is obtained.

The obtained reverse osmosis retentate can have an ash content of between 3 and 7%, preferably between 4 and 6%. For the purposes of the invention, the term “ash” is understood to mean the product resulting from incineration of the dry matter of the retentate. According to the invention, the ash content is determined according to standard NF 04-208.

The method then comprises a step iii) of neutralizing the reverse osmosis retentate to a pH of between 6 and 9. The neutralization may for example be carried out independently, by means of a solution of potassium hydroxide, sodium hydroxide, calcium hydroxide, or mixtures thereof.

In a first variant of this step, the reverse osmosis retentate is neutralized to a pH of between 6.5 and 9. According to this variant, neutralization of the retentate leads to the formation of di- and tricalcium phosphate which precipitates in the form of crystals. Indeed, the inventors have observed that starting at a pH of 6.5, a precipitate is obtained regardless of the basic solution used for the neutralization. A mechanical separation step can then advantageously be implemented in order to remove the precipitate of di- and tricalcium phosphate and thus reduce the fouling and deterioration of the membranes during the subsequent nanofiltration step. The mechanical separation step is carried out according to means known to those skilled in the art, by using a decanter or a centrifuge, the supernatant then being used for the rest of the method according to the invention.

In a second variant of this step, the reverse osmosis retentate is neutralized to a pH of between 6 and 6.4, and implementation of a mechanical separation step is then unnecessary because the phosphates are primarily in their soluble mono- and dicalcium form which to all appearances remain soluble.

The fourth step iv) of the method then consists of the treatment by nanofiltration of the neutralized reverse osmosis retentate from the whey demineralization effluents, in order to separate the monovalent ions from the divalent ions and also to remove the majority of the residual organic matter, for example such as organic acids, peptides, amino acids, or even lactose.

Nanofiltration is also a technique known to those skilled in the art. It is a method for separating compounds contained in a liquid, via the use of a semi-permeable membrane in which the pore diameter can vary for example from 1 to 10 nm.

According to this step iv) of the treatment method, the neutralized retentate obtained in step iii) is treated by means of nanofiltration, to obtain a nanofiltration permeate mainly comprising the monovalent ions, and a nanofiltration retentate mainly comprising the divalent ions.

The nanofiltration step can be carried out until a concentration factor (CF) in the retentate of 2 to 4 is obtained. Preferably, the nanofiltration can be carried out until a concentration factor (CF) in the retentate that is approximately equal to 3 is obtained.

According to one particular embodiment, the retentate comprising the divalent ions is advantageously reused in animal feed.

Finally, the fifth step v) of the method consists of treating the nanofiltration permeate mainly containing the monovalent ions, obtained in step iv), by means of electrodialysis with bipolar membrane, so as to obtain at least one acidic solution and at least one basic solution.

Electrodialysis with bipolar membrane, or bipolar electrodialysis, is a technique known to those skilled in the art which, unlike conventional electrodialysis, makes it possible to dissociate the H⁺ and OH⁻ ions contained in solution and thus to convert saline solutions into acids and bases.

This bipolar electrodialysis step is carried out until a permeate conductivity of between 0.2 mS/cm and 1.2 mS/cm is obtained.

The method according to the invention thus makes it possible to treat the demineralization effluents and in particular to obtain acidic and basic solutions which can advantageously be used for other industrial applications.

A second object of the invention relates to a method for demineralizing whey and for treating the effluents produced, comprising the following steps:
a) supplying a whey,
b) acidifying the whey to a pH of between 2.0 and 3.5,
c) electrodialyzing the acidified whey,
d) recovering the electrodialysis brine from step c) and implementing a method for treating demineralization effluents according to the invention, said demineralization effluent in step i) being said electrodialysis brine.

According to the invention, the whey may be a sweet whey or an acid whey.

In the context of the invention, the acid whey may be the liquid obtained by coagulation of milk via acidification caused by the metabolism of lactic acid bacteria. In general, the composition of acid whey is as follows:
lactose: 4.0-5.0%
proteins: 0.6-0.7%
mineral salts (mainly Na⁺, K⁺ and Ca²⁺): 0.7-0.8%
fat: 0.05-0.1%
dry matter content (total dry extract): 5.3-6.0%
acidity: pH 4.3-4.6

In the context of the invention, the term sweet whey denotes the liquid obtained after coagulation of casein by rennet during the manufacture of cheese. As mentioned above, sweet whey is a known co-product that comes from the cheese industry. In general, the composition of sweet whey is as follows:
lactose: 4.0-5.0%
proteins: 0.6-0.8%
mineral salts (mainly Na⁺, K⁺ and Ca²⁺): 0.4-0.6%
fat: 0.2-0.4%
dry matter content (total dry extract): 5.3-6.6%
acidity: pH 5.9-6.5

According to a preferred embodiment, the whey provided is a sweet whey. According to this embodiment, the sweet whey may be in unprocessed form or in concentrated form. Similarly, it may also be a whey reconstituted from whey powder.

According to a variant of this preferred embodiment, the sweet whey is a concentrated sweet whey, advantageously concentrated by heat under moderate heating conditions until a dry extract of between 18 to 25% is obtained. Preferably, the sweet whey presents a dry extract of 18 to 23%, and more particularly a dry extract of about 20%. Whey can also be defined by its conductivity characteristics and ash content. According to this embodiment, the concentrated whey provided has a conductivity Q of between 13.5 and 14.5 mS/cm at 20° C. and an ash content of between 7.8 and 8.4%.

Step b) of the method consists of acidifying the whey provided. The acidification is carried out to decrease the pH of the whey and maintain it at a value between 2.0 and 3.5. Preferably, the pH of the whey is lowered to and maintained at a value between 2.5 and 3.2, and more preferably at a value approximately equal to 3. The acidification may be carried out by means known to those skilled in the art, for example such as the use of a hydrochloric acid (HCl) solution.

This acidification of the whey offers several advantages, particularly for the efficiency of the electrodialysis. On the one hand, the efficiency is increased because the low pH promotes ionization of the divalent and trivalent salts present in the whey, and thus increases, for example, the availability of calcium or magnesium. On the other hand, this makes it possible to lower the viscosity of the whey and results in better passage of the ions through the electrodialysis membranes. As a result, fouling of the membranes is reduced and their service life is increased. In addition, maintaining the whey at a pH between 2 and 3.5 makes it possible to ensure thermal stability of the serum proteins by preventing their flocculation and their denaturation during a step of high-temperature pasteurization. This point is of particular interest for maintaining the nutritional quality of demineralized whey. Advantageously, the acid pH also prevents any bacteriological growth during the demineralization operation.

Lastly, the maintaining of acid conditions according to the invention in the demineralization process is also advantageous in that it makes it possible to reduce the consumption of water and chemicals.

According to one particular embodiment, the method may also comprise a step b′) of pasteurizing the acidified whey before the demineralization step c). Pasteurization makes it possible to significantly reduce the number of microorganisms present in the whey, and in particular to eliminate the most resistant bacteria, such as spore-forming and heat-resistant bacteria, but without altering the proteins. This pasteurization step is carried out at a temperature of between 90° C. and 125° C. and for a period of between 5 seconds and 30 minutes.

Next, step c) of the method for demineralizing whey and treating the products consists of a step of electrodialyzing the acidified whey, to produce a diluate and a concentrate.

The diluate corresponds to the demineralized whey, while the concentrate refers to the concentrated salt solution which is also called demineralization effluent or brine.

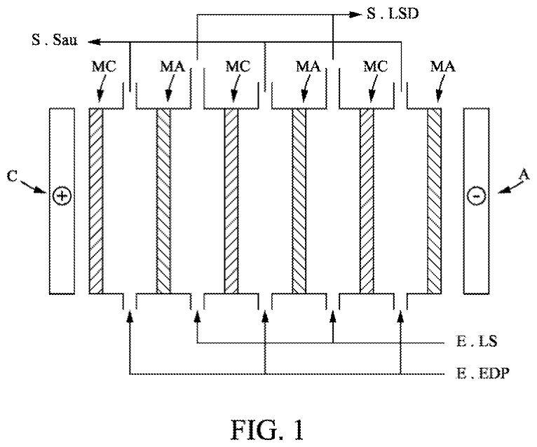

The electrodialysis according to this step, called conventional electrodialysis, is a technique known to those skilled in the art, which may for example be carried out as shown in FIG. 1. The electrodialyzer comprises compartments separated from each other by membranes which are alternately anionic and cationic. A first compartment contains the whey to be demineralized while a second contains acidified water at a pH of 1.5 to 3.5. During the action of the electric field at each end of the electrodialyzer by means of electrodes, the cations exit the first compartment by crossing the cationic membrane and are held in the second compartment by the anionic membrane. The anions also exit the first compartment by migrating in the direction of the anionic membrane and are blocked by the cationic membrane. Consequently, the first compartment sees its concentration of dissolved salts decrease while the second compartment sees its concentration of dissolved salts increase. One compartment is being diluted, the other is being concentrated, the next is being diluted, the other is being concentrated, and so on.

This electrodialysis step can be carried out at a temperature between 30° C. and 60° C., preferably at a temperature between 35° C. and 55° C., and more preferably at a temperature between 40° C. and 50° C. For example, this electrodialysis step can be carried out at a temperature of about 45° C.

The electrodialysis step is carried out until the desired demineralization level is reached, namely for this step a demineralization level of at least 70%, at least 75%, at least 80%, at least 85%, and more particularly a demineralization level of about 90%. Preferably, the electrodialysis is carried out so as to obtain a demineralization level of approximately 90%.

The expression “demineralization level” represents the ratio of the amounts of mineral salts eliminated from the whey (meaning the difference between the amounts of mineral salts in the initial whey and the residual amounts in the demineralized whey) to the amounts of mineral salts in the initial whey, brought to the same percentages of dry matter.

Those skilled in the art can evaluate the demineralization level of whey by means of conductivity. In addition, the ash content of demineralized whey can also be an indicator of the demineralization level achieved. For the purposes of the invention, the term “ash” is understood to mean the product resulting from incineration of the dry matter of the whey. According to the invention, the ash content is determined according to standard NF 04-208.

The electrodialysis step can thus be carried out so as to obtain a conductivity of the whey, acidified and concentrated to 20% dry extract, of between 2.0 and 3.0 mS/cm, and/or an ash content of between 2.2 and 2.6%/dry extract, which corresponds to a demineralization level of approximately 70%.

According to one particular embodiment, the electrodialysis is carried out so as to obtain a conductivity of the whey, concentrated to 20% dry extract, of between 1.0 and 1.5 mS/cm, and/or an ash content of between 0.6 and 1.2%/dry extract which corresponds to a demineralization level of about 90%. To do this, when the conductivity of the acidified whey reaches between 2.0 and 3.0 mS/cm during electrodialysis, the latter must be paused while the whey is neutralized to a pH of between 6 and 7. Then the electrodialysis is resumed until the target conductivity of between 1.0 and 1.5 mS/cm.

According to one particular embodiment, the method for demineralizing whey and for treating the effluents produced comprises a step e) of recovering the demineralized whey.

The brine from electrodialysis thus produced according to step c) is then recovered and used in the method for treating demineralization effluents according to the invention as defined above.

Thus, said recovered brine is the whey demineralization effluent supplied in step i). In summary, the method for demineralizing whey and for treating the effluents produced comprises the following steps:
a) supplying a whey,
b) acidifying the whey to a pH of between 2.0 and 3.5,
c) electrodialyzing the acidified whey,
d) recovering the electrodialysis brine from step c) and implementing a method for treating demineralization effluents comprising the following steps:
   ii) treating by reverse osmosis the electrodialysis brine so as to obtain a reverse osmosis permeate and retentate,
   iii) neutralizing the reverse osmosis retentate to a pH of between 6 and 9,
   iv) treating the neutralized reverse osmosis retentate by nanofiltration so as to obtain a nanofiltration permeate mainly comprising the monovalent ions and a nanofiltration retentate mainly comprising the divalent ions,
   v) treating the nanofiltration permeate obtained in step iv) by electrodialysis with bipolar membrane so as to separate out at least one acidic solution and at least one basic solution.

According to one particularly advantageous embodiment, the method for demineralizing whey and for treating effluents further comprises a step of recycling all or part of the reverse osmosis permeate from step ii), as process water for step c) of electrodialyzing the acidified whey or sweet whey.

According to another particularly advantageous embodiment, the method for demineralizing whey and for treating effluents further comprises a step of recycling all or part of the acidic solution which is separated out after electrodialysis with bipolar membrane according to step v), for acidification of the whey according to step b).

According to another particularly advantageous embodiment, the method for demineralizing whey and for treating effluents further comprises a step of recycling all or part of the basic solution which is separated out after electrodialysis with bipolar membrane according to step v), for neutralization of the reverse osmosis retentate according to step iii) and/or for neutralization of the demineralized whey produced in the electrodialysis step c).

For the purposes of the invention, the expression “process water” is considered to be synonymous with the term “brine” except when the context clearly identifies that such is not the case.

As previously mentioned, the amounts of brine produced on an industrial scale by means of whey demineralization are very large. The method according to the invention thus makes it possible to treat these effluents, to limit their environmental impact, and to generate solutions which can be used in the whey demineralization process as such. Advantageously, this also makes it possible to reduce the cost of whey demineralization since part of the electrodialysis process water comes from treating the effluents generated. The method according to the invention makes it possible to reduce the total amount of effluent sent to the waste treatment plant.

A third object of the invention relates to a facility suitable for implementing the method for demineralizing whey and for treating effluents according to the invention as defined above.

Such a facility thus comprises:
a first electrodialysis device comprising a first inlet intended to receive the whey, a second inlet intended to receive the process water, a first outlet for the demineralized whey, and a second outlet for the demineralization effluent,
an effluent treatment system comprising:
   a reverse osmosis device comprising a first inlet for the demineralization effluent which is connected to the second outlet of the electrodialysis device, a first outlet for the reverse osmosis permeate, and a second outlet for the reverse osmosis retentate,
   a neutralization device comprising a first inlet for the reverse osmosis retentate which is connected to the second outlet of the reverse osmosis device, a second inlet for a neutralization solution, and an outlet for the neutralized reverse osmosis retentate,
   a nanofiltration device comprising an inlet for the neutralized reverse osmosis retentate which is connected directly to the outlet of the neutralization device or indirectly via a mechanical separation device, a first outlet for the neutralized nanofiltration retentate, and a second outlet for the nanofiltration permeate,
   a second electrodialysis device with bipolar membrane having an inlet for the nanofiltration permeate and connected to the second outlet of the nanofiltration device, a first outlet for an acidic solution, a second outlet for a basic solution,
said effluent treatment system comprising all or part of the following recycling means:
   a means connecting the first outlet for the reverse osmosis permeate of the reverse osmosis device with the second inlet of the first electrodialysis device, and/or
   a means connecting the first outlet for an acidic solution of the second electrodialysis device with bipolar membrane with the second inlet of the first electrodialysis device, and/or
   a means connecting the second outlet for a basic solution of the second electrodialysis device on bipolar membrane with the second inlet for a neutralization solution of the neutralization device and/or with the first outlet for a demineralized whey of the first electrodialysis device.

The first electrodialysis device makes it possible to implement step c) of the method according to the invention so as to demineralize the whey to the desired demineralization level. This device comprises a first inlet intended to receive the whey, a second inlet intended to receive the solution of process water, a first outlet for the demineralized whey, and a second outlet for the brine or demineralization effluent. The process water is the water used to feed the electrodialyzer. At the end of electrodialysis, this water constitutes the demineralization effluent as described above.

The facility according to the invention also comprises a treatment system which, by making use of a succession of devices, has the aim of treating the brine produced by whey demineralization. The treatment system thus comprises a reverse osmosis device. This device makes it possible to implement step ii) of the method according to the invention so as to generate, from the brine, a reverse osmosis permeate and a reverse osmosis retentate. The reverse osmosis device comprises a first inlet for the demineralization effluent which is connected to the second outlet of the electrodialysis device, a first outlet for the reverse osmosis permeate, and a second outlet for the reverse osmosis retentate which is connected to the neutralization device.

The neutralization device makes it possible to implement step iii) of the method according to the invention and to neutralize the reverse osmosis retentate before the latter is treated by a nanofiltration device. This device comprises a first inlet for the reverse osmosis retentate which is connected to the second outlet of the reverse osmosis device, a second inlet for a neutralization solution, as well as an outlet for the neutralized reverse osmosis retentate, said outlet being connected to a nanofiltration device or a mechanical separation device.

This neutralization device makes it possible to neutralize the pH of the reverse osmosis retentate, from 6 to 9. In the case where the pH is neutralized from 6 to 6.4, the outlet of the neutralization device can be directly connected to the first inlet of the nanofiltration device. However, in the case where the pH is neutralized from 6.5 to 9, the outlet of the neutralization device is connected to a mechanical separation device in order to remove the tricalcium phosphate precipitate from the retentate.

The mechanical separation device thus comprises an inlet for the neutralized reverse osmosis retentate and an outlet for the separation supernatant free of tricalcium phosphate. The outlet of the mechanical separation device is then connected to the inlet of the nanofiltration device.

The nanofiltration device makes it possible to implement step iv) of the treatment method according to the invention in order to obtain a nanofiltration permeate mainly comprising the monovalent ions and a nanofiltration retentate mainly comprising the divalent ions. This device comprises an inlet for the neutralized reverse osmosis retentate which is connected directly to the outlet of the neutralization device or to the outlet of the mechanical separation device, a first outlet for the neutralized nanofiltration retentate, and a second outlet for the nanofiltration permeate.

Finally, the treatment system comprises an electrodialysis device with bipolar membrane, making it possible to implement step v) of the method according to the invention. This device is similar to the first electrodialysis device except that it also contains bipolar membranes and thus makes it possible to obtain acidic and basic solutions from a saline solution due to dissociation of the H⁺ and OH⁺ ions. The bipolar electrodialysis device thus comprises an inlet for the nanofiltration permeate and which is connected to the second outlet of the nanofiltration device, a first outlet for an acidic solution, and a second outlet for a basic solution.

The facility according to the invention is particularly advantageous in that the treatment system also comprises one or more recycling means. Indeed, a first recycling means can connect the first outlet of the reverse osmosis device with the second inlet of the first electrodialysis device. This first recycling means thus makes it possible to recycle all or part of the reverse osmosis permeate generated by the reverse osmosis device, as process water at the electrodialysis device.

A second recycling means can connect the first outlet of the electrodialysis device with bipolar membrane with the second inlet of the first electrodialysis device. This second means thus makes it possible to recycle all or part of the acidic solution generated by the electrodialysis device with bipolar membrane, for acidification of the whey according to step b) of the method for demineralizing whey and for treating effluents.

Finally, a third recycling means can connect the second outlet of the electrodialysis device with bipolar membrane with the second inlet of the neutralization device and/or the first outlet for demineralized whey of the first electrodialysis device. This third means makes it possible to recycle all or part of the basic solution generated by the electrodialysis device with bipolar membrane, for neutralization of the reverse osmosis retentate in the neutralization device and/or for neutralization of the whey at the end of demineralization.

The invention will be better understood with the aid of the following examples, which are purely illustrative and in no way limit the scope of the protection.

### EXAMPLES

### Example 1

The aim of this example is to implement the method for treating demineralization effluent according to the invention.

A. Supplying the Demineralization Effluent:

The effluent treated according to this example is a brine resulting from demineralization of a sweet whey having the ion concentrations and characteristics summarized in Table 1 below:

TABLE 1.1

| | |
|---|---|
| Dry extract (%) | 21.8 |
| pH | 6.7 |
| Conductivity (mS/cm) | 20.28 |

The recovered brine has a pH of 2.4 and the ion concentrations are as presented in Table 1.2 below:

TABLE 1.2

| | K⁺ | Na⁺ | Ca2⁺ | Mg2⁺ | Cl⁻ | P | Ash (%) |
|---|---|---|---|---|---|---|---|
| Concentrations | 674 | 163 | 62 | 13 | 808 | 77 | 1.9 |
| (mg/100 g liquid) | | | | | | | |

B. Treatment of Brine Generated by Demineralization of Sweet Whey

Reverse Osmosis:

The brine obtained after demineralization of sweet whey is treated by reverse osmosis according to step b) of the method of the invention. Reverse osmosis is carried out starting with 40 L of brine until a concentration factor (CF) equal to 4 is obtained in the retentate. The final volume in the retentate is then 10 L and the final volume in the permeate is 30 L.

The characteristics of the reverse osmosis are presented in Table 1.3 below:

TABLE 1.3

| | AG 1812 |
|---|---|
| Membrane | (GE Membranes) |
| Target pressure (bar) | 30 |
| Flow rate (L/h) | 900 |
| Initial volume (L) | 40 |
| Desired CF | 4 |
| Final volume of retentate (L) | 10 |
| Final volume of permeate (L) | 30 |
| Temperature | 45° C. |

The COD, the dry extract percentage, the ash content, the pH, as well as the concentrations (mg/100 g) of the various ions in the retentate were measured at different CF and up to the target CF, are presented in Table 1.4 below:

TABLE 1.4

| CF | K | Na | Ca | Mg | Cl | P | COD | DE % | Ash % | pH |
|---|---|---|---|---|---|---|---|---|---|---|
| 1.00 | 610 | 148 | 66 | 13 | 776 | 74 | 569 | 2.6 | 1.9 | 2.53 |
| 1.33 | 820 | 191 | 83 | 17 | 1100 | 100 | 817 | 3.3 | 2.4 | 2.55 |
| 2 | 1189 | 278 | 129 | 24 | 1413 | 140 | 1300 | 4.6 | 3.3 | 2.58 |
| 4 | 1979 | 474 | 217 | 37 | 2310 | 244 | 2128 | 7.7 | 5.5 | 2.61 |

This reverse osmosis step is repeated two more times under the same conditions, in order to obtain an additional 20 liters of retentate and thus bring the total volume of the reverse osmosis retentate obtained to 30 liters.

Nanofiltration:

The reverse osmosis retentate is then neutralized at 20° C. to pH 7 with a 40% (by weight) NaOH solution, and a tricalcium phosphate precipitate forms.

The 30 liters of reverse osmosis retentate are then decanted for 12 hours, and 21 L of supernatant are obtained. It is therefore the 21 L of supernatant which are then nanofiltered.

Nanofiltration is carried out until a concentration factor equal to 3 is obtained in the nanofiltration permeate. The characteristics of the nanofiltration are presented below:

TABLE 1.5

| | DK 1812 |
|---|---|
| Membrane | (GE Membrane) |
| Target pressure (bar) | 25 |
| Flow rate (L/h) | 900 |
| Initial volume (L) | 21 |
| Desired CF | 3 |
| Final volume of retentate (L) | 10 |
| Final volume of permeate (L) | 20 |
| Temperature | 20° C. |

Nanofiltration of the 21 L of supernatant makes it possible to obtain 14 L of nanofiltration permeate containing only the monovalent ions, such as K⁺ and Na⁺.

The COD, the dry extract percentage, the ash content (%), the pH, as well as the concentrations (mg/100 g) of the various ions in the permeate, were measured and are presented in Table 1.6 below:

TABLE 1.6

| CF | K | Na | Ca | Mg | Cl | P | COD | DE | Ash | pH |
|---|---|---|---|---|---|---|---|---|---|---|
| 1.0 | 1484 | 853 | 77 | 25 | 1904 | 119 | 1554 | 6.6 | 5.2 | 6.47 |
| 3.0 | 2204 | 1147 | 150 | 59 | 1655 | 288 | 3004 | 10.3 | 4.9 | 6.52 |

Electrodialysis with Bipolar Membrane:

The nanofiltration permeate is then treated by electrodialysis with bipolar membrane. The treatment is done in two steps in this example.

The first step begins with a volume of 7 L of permeate in the feed compartment, 5 L of water in the acid compartment, and 5 L of water in the base compartment.

Electrodialysis is initiated in order to reduce the conductivity of the permeate, initially equal to 50 mS/cm, to a value below 0.5 mS/cm.

As soon as the conductivity of 0.5 mS/cm is reached, a second step is carried out with 7 new liters of permeate in the feed compartment. The acid and base produced are unchanged, however, in order to allow them to become even further concentrated. The conductivity goal for the feed is the same as in the first step.

At the end of the electrodialysis, the final measured conductivity of the permeate is 1.1 mS/cm, the acidic solution has a concentration equal to 1.08 mol/L, and the basic solution has a concentration of 0.87 mol/L.

The values of the conductivities of the permeate are given in Table 1.7 below:

TABLE 1.7

| | Conductivity |
|---|---|
| | (mS/cm) |
| Start of 1^{st} step | 50.0 |
| End of 1st step | 0.51 |
| Start of 2^{nd} step | 50.0 |
| End of 2^{nd} step | 1.09 |

Below are the concentrations in the acidic solution and basic solution, obtained at the end of steps 1 and 2:

TABLE 1.8

| | Unit | Acid | Base |
|---|---|---|---|
| Step 1 | Mol/L of H⁺ | 0.61 | 0.43 |
| | Mass % of HCl | 2.2 | 3.9 |
| Step 2 | Mol/L of OH⁻ | 1.08 | 0.87 |
| | Mass % of NaOH | 1.7 | 3.5 |

Finally, Table 1.9 below shows the mineral compositions (mg/100 g of liquid) of the acidic and basic solution at the end of each step:

TABLE 1.9

| | | K | Na | Ca | Mg |
|---|---|---|---|---|---|
| Step 1 | Acidic | 22 | 87 | 4.4 | 1.3 |
| | solution | | | | |
| | Basic | 6 | 705 | 5.9 | 0 |
| | solution | | | | |
| Step 2 | Acidic | 229 | 201 | 5.3 | 1.4 |
| | solution | | | | |
| | Basic | 2006 | 1208 | 5.2 | 0 |
| | solution | | | | |

At the end of the bipolar electrodialysis, the molar ratio between the potassium and sodium concentrations in the basic solution is 49/51 (K/Na). The base produced therefore seems to be a basic solution composed of potash and soda in a 50/50 molar ratio.

The method according to the invention thus makes it possible to treat the brine resulting from whey demineralization in order to obtain, in particular, acidic and basic solutions which can be reused for other applications.

### Example 2

Using a different whey than in Example 1, the aim of this example is to implement the method for demineralizing whey and for treating the produced effluents according to the invention.

A. Production of Whey Demineralization Effluent:

The sweet whey used for the demineralization has the ion concentrations and characteristics listed in Table 2.1 below:

TABLE 2.1

| | |
|---|---|
| Dry extract (%) | 23.0 |
| pH | 6.2 |
| Conductivity (mS/cm) | 22.05 |

The sweet whey is then acidified to pH 3 at the start of demineralization, with an acidic solution produced in Example 1.

Starting with 19.7 L of whey, a first electrodialysis step is carried out until a conductivity of the whey of about 3 mS/cm is obtained.

The whey is then neutralized to pH 6.2 with the basic solution produced in Example 1, then a second electrodialysis step is carried out until the conductivity of the whey is reduced to approximately 1.6 mS/cm.

The ion concentrations (mg/100 g of dry extract) in the whey at the start and end of the electrodialysis (ED) are given in Table 2.2 below:

TABLE 2.2

| | K | Na | Ca | Mg | Cl | P | Ash (%) |
|---|---|---|---|---|---|---|---|
| Starting | 2692 | 700 | 600 | 117 | 3878 | 570 | 8.48 |
| concentration ED | | | | | | | |
| Ending | 203 | 181 | 240 | 66 | 42 | 222 | 1.61 |
| concentration ED | | | | | | | |

The brine circuit of the electrodialyzer initially contains 20 L of process water which is not changed between the two electrodialysis steps. At the end of the electrodialysis, the brine is recovered and has a pH of 2.4.

The ion concentrations in the brine were measured at the start and end of the electrodialysis and are listed below:

TABLE 2.3

| | K | Na | Ca | Mg | Cl | P | Ash (%) |
|---|---|---|---|---|---|---|---|
| Start of electrodialysis | 0 | 3 | 8 | 0 | 3 | 1 | 0.54 |
| (in mg/100 g liquid) | | | | | | | |
| End of electrodialysis | 610 | 203 | 71 | 13 | 823 | 74 | 1.89 |
| (in mg/100 g liquid) | | | | | | | |

B. Recycling the Brine Generated by Whey Demineralization

Reverse Osmosis:

In the same manner as in Example 1, reverse osmosis is carried out starting with 40 L of brine, until a concentration factor (CF) equal to 4 is obtained in the retentate. The final volume in the retentate is then 10 L and the final volume in the permeate is 30 L. This reverse osmosis step is repeated twice in order to obtain 20 L of additional retentate. The total volume of the reverse osmosis retentate thus obtained is 30 liters.

The characteristics of the reverse osmosis are identical to those of Example 1.

The concentrations (mg/100 g) of the various ions in the retentate measured at different CF:

TABLE 2.4

| CF | K | Na | Ca | Mg | Cl | P | COD | DE | Ash % | pH |
|---|---|---|---|---|---|---|---|---|---|---|
| 1.00 | 540 | 169 | 69 | 12 | 768 | 70 | 459 | 2.6 | 1.69 | 2.48 |
| 1.33 | 658 | 216 | 85 | 15 | 950 | 91 | / | 3.4 | 2.27 | 2.45 |
| 2.00 | 954 | 309 | 119 | 22 | 1397 | 129 | / | 4.7 | 3.08 | 2.55 |
| 4.00 | 1564 | 491 | 189 | 33 | 1986 | 198 | 1353 | 6.9 | 4.85 | 2.53 |

Nanofiltration:

The reverse osmosis retentate is then neutralized to pH 8.6 with a solution of KOH/NaOH (at 0.5M KOH and 0.5M NaOH) reconstituted from the basic solution obtained in Example 1. A precipitate of tricalcium phosphate forms.

The reverse osmosis retentate is then decanted for 12 hours and 17 L of supernatant are obtained. It is therefore the 17 L of supernatant which are then nanofiltrated.

Nanofiltration is carried out until a concentration factor equal to 3 in the nanofiltration permeate is obtained. The characteristics of the nanofiltration are identical to those of Example 1.

The ion concentrations in the nanofiltration retentate are listed below:

TABLE 2.5

| CF | K | Na | Ca | Mg | Cl | P | COD | DE % | Ash % |
|---|---|---|---|---|---|---|---|---|---|
| 1.0 | 807 | 392 | 1 | 0 | 1219 | 1 | 2 | 2.7 | 2.50 |
| 1.5 | 1064 | 496 | 1 | 0 | 1540 | 1 | / | 3.4 | 3.17 |
| Overall (3) | 989 | 465 | 1 | 0 | 1639 | 1 | 4 | 3.2 | 3.07 |

Nanofiltration of the 17 L of supernatant makes it possible to obtain 11.5 L of nanofiltration permeate containing only the monovalent ions, such as K⁺ and Na⁺.

Electrodialysis with Bipolar Membrane:

The nanofiltration permeate is then treated by electrodialysis with bipolar membrane according to the same protocol as Example 1, by a two-step treatment.

The first step begins with a volume of 5.5 L of permeate in the feed compartment, 5 L of water in the acid compartment, and 5 L of water in the base compartment.

Electrodialysis is initiated in order to reduce the conductivity of the permeate, initially equal to 50 mS/cm, to a value less than 1 mS/cm.

The second step is carried out with 5.5 new liters of permeate in the feed compartment. The acidic and basic solutions produced are unchanged, however, in order to allow their further concentration. The conductivity goal for the feed is the same as in the first step, namely a conductivity of less than 1 mS/cm.

At the end of the electrodialysis, the final measured conductivity of the permeate is 0.7 mS/cm, the acidic solution has a concentration equal to 0.69 mol/L, and the basic solution has a concentration of 0.64 mol/L.

The values of the conductivities of the permeate are given in Table 2.6 below:

TABLE 2.6

| | Conductivity |
|---|---|
| | (mS/cm) |
| Start of 1^{st} step | 50.0 |
| End of 1^{st} step | 0.7 |
| Start of 2^{nd} step | 46 |
| End of 2^{nd} step | 0.7 |

Below are the concentrations in the acidic solution and basic solution, obtained at the end of steps 1 and 2:

TABLE 2.7

| | Unit | Acid | Base |
|---|---|---|---|
| Step 1 | Mol/L of H⁺ | 0.34 | 0.32 |
| | Mass % of HCl | 1.2 | 1.3 |
| Step 2 | Mol/L of OH⁻ | 0.69 | 0.64 |
| | Mass % of NaOH | 2.5 | 2.6 |

Finally, Table 2.8 below shows the mineral compositions (mg/100 g of liquid) of the acidic and basic solution at the end of each step:

TABLE 2.8

| | | K | Na |
|---|---|---|---|
| Step 1 | Acidic | 37 | 33 |
| | solution | | |
| | Basic | 604 | 332 |
| | Solution | | |
| Step 2 | Acidic | 67 | 46 |
| | solution | | |
| | Basic | 1308 | 658 |
| | Solution | | |

At the end of the bipolar electrodialysis, the molar ratio between the potassium and sodium concentrations in the basic solution is 54/46 (K/Na). The base produced therefore seems to be a basic solution composed of potash and soda in a 50/50 molar ratio.

The method according to the invention thus makes it possible to demineralize whey and treat the brine in order to obtain, in particular, acidic and basic solutions which can be reused in the demineralization process as such, thus limiting discharges to a wastewater treatment plant.

### Example 3

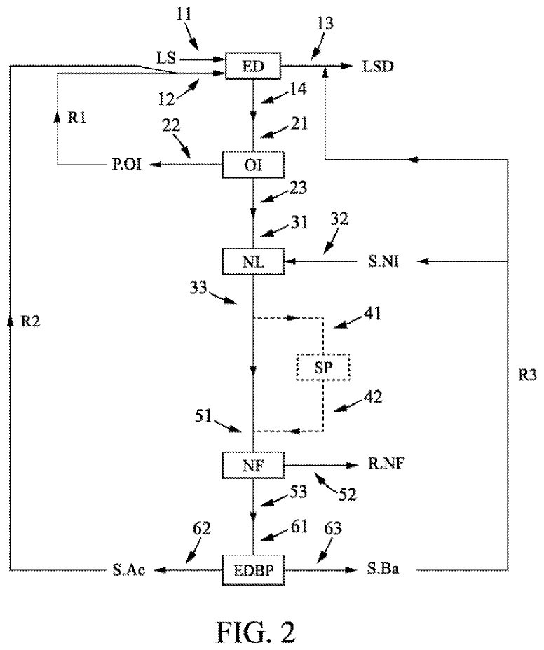

The purpose of this example is to present a facility suitable for implementing the method according to the invention. Said facility is presented schematically in FIG. 2, and comprises:
a first electrodialysis device ED comprising a first inlet 11 intended to receive the whey, a second inlet 12 intended to receive the process water, a first outlet 13 for the demineralized whey, and a second outlet 14 for the demineralization effluent,
an effluent treatment system comprising:
   a reverse osmosis device OI comprising an inlet 21 for the demineralization effluent connected to the second outlet 14 of the electrodialysis device, a first outlet 22 for the reverse osmosis permeate, and a second outlet 23 for the reverse osmosis retentate,
   a neutralization device NL comprising a first inlet 31 for the reverse osmosis retentate connected to the second outlet 23 of the reverse osmosis device, a second inlet 32 for a neutralization solution, and an outlet 33 for the neutralized reverse osmosis retentate,
   a nanofiltration device NF comprising an inlet 51 for the neutralized reverse osmosis retentate connected directly to the outlet 33 of the neutralization device, a first outlet 52 for the neutralized nanofiltration retentate, and a second outlet 53 for the nanofiltration permeate,
   a second electrodialysis device with bipolar membrane EDBP having an inlet 61 for the nanofiltration permeate and connected to the second outlet 53 of the nanofiltration device NF, a first outlet 62 for an acidic solution, a second outlet 63 for a basic solution,
said system comprising recycling means comprising all or part of the following means:
   a means R1 connecting the first outlet 22 for the reverse osmosis permeate of the reverse osmosis device with the second inlet 12 of the first electrodialysis device ED intended to receive the process water, and/or
   a means R2 connecting the first outlet 62 for an acidic solution of the second electrodialysis device with bipolar membrane EDBP with the second inlet 12 of the first electrodialysis device, and/or
   a means R3 connecting the second outlet 63 for a basic solution of the second electrodialysis device with bipolar membrane EDBP with the second inlet 32 of the neutralization device NL and/or with the first outlet 13 of the first electrodialysis device ED.

In the case where the neutralization is carried out at a pH of 6.5 to 9, the outlet 33 for the neutralized reverse osmosis retentate of the neutralization device NL is connected by a pipe to the inlet 41 of the mechanical separation device, and the outlet 42 of the latter device is connected by a pipe to the inlet 51 of the nanofiltration device.

In the case where the method is carried out continuously, the connections and the means connecting the various inlets and outlets of the devices are ensured by pipes.

### NAMING CONVENTIONS IN THE FIGURES

A: Anode
C: Cathode
SP: mechanical separation device
E.EDP: inlet for process water
E.LS: inlet for whey
ED: electrodialysis device
EDBP: electrodialysis device with bipolar membrane
LS: Whey
LSD: Demineralized whey
MA: anionic membrane
MC: cationic membrane
NF: nanofiltration device
NL: neutralization device
OI: reverse osmosis device
P.OI: reverse osmosis permeate
R.NF: Nanofiltration retentate
S.Ac: Acidic solution
S.Ba: Basic solution
S.LSD: outlet for demineralized whey
S.NI: Neutralization solution
S.Sau: outlet for brine
R1: first recycling means
R2: second recycling means
R3: third recycling means
11: first inlet for whey
12: second inlet for process water
13: first outlet for demineralized whey
14: second outlet for demineralization effluent
21: inlet for demineralization effluent
22: first outlet for reverse osmosis permeate
23: second outlet for reverse osmosis retentate
31: first inlet for reverse osmosis retentate
32: second inlet for neutralization solution
33: outlet for neutralized reverse osmosis retentate
41: inlet for neutralized reverse osmosis retentate
42: outlet for separation supernatant free of tricalcium phosphate
51: inlet for neutralized reverse osmosis retentate
52: first outlet for nanofiltration retentate
53: second outlet for nanofiltration permeate
61: inlet for nanofiltration permeate
62: first outlet for acidic solution
63: second outlet for basic solution

1-10. (canceled)

11. A method for treating whey demineralization effluents, comprising the following steps:
i) supplying a whey demineralization effluent,
ii) treating by reverse osmosis the effluent recovered in step i) so as to obtain a reverse osmosis permeate and retentate,
iii) neutralizing the reverse osmosis retentate to a pH of between 6 and 9,
iv) treating the neutralized reverse osmosis retentate by nanofiltration so as to obtain a nanofiltration permeate comprising the monovalent ions and a nanofiltration retentate comprising the divalent ions and the residual organic materials, and
v) treating the nanofiltration permeate obtained in step iv) by electrodialysis with bipolar membrane, so as to obtain at least one acidic solution and at least one basic solution.

12. The method according to claim 11, wherein the whey demineralization effluent is a brine from electrodialysis of whey, preferably of sweet whey.

13. The method according to claim 11, wherein step ii) is carried out so as to obtain a concentration factor (CF) of 3 to 5 in the retentate.

14. The method according to claim 11, wherein the neutralization in step iii) is carried out to a pH between 6.5 and 9 and wherein it also comprises a step of mechanical separation of the neutralized retentate so as to remove the tricalcium phosphate precipitate, the step iv) of nanofiltration then being carried out on the separation supernatant free of tricalcium phosphate.

15. The method according to claim 11, wherein the step v) of electrodialysis with bipolar membrane is carried out so as to obtain a conductivity of the permeate of between 0.2 and 1.2 mS/cm.

16. A method for demineralizing whey and for treating the effluents produced, comprising the following steps:
a) supplying a whey,
b) acidifying the whey to a pH of between 2.0 and 3.5,
c) electrodialyzing the acidified whey,
d) recovering the electrodialysis brine and implementing a method for treating demineralization effluents according to claim 1, said demineralization effluent in step i) being said electrodialysis brine.

17. The method according to claim 16, further comprising a step of recycling all or part of the acidic solution which is separated out after electrodialysis with bipolar membrane according to step v), for acidification of the whey according to step b).

18. The method according to claim 16, further comprising a step of recycling all or part of the basic solution which is separated out after electrodialysis with bipolar membrane according to step v), for neutralization of the reverse osmosis retentate according to step iii).

19. The method according to claim 16, further comprising a step of recycling all or part of the reverse osmosis permeate from step ii), as process water for step c) of electrodialyzing the acidified whey.

20. A facility suitable for demineralizing whey and for treating the effluents produced, said facility comprising:
a first electrodialysis device comprising a first inlet intended to receive the whey, a second inlet intended to receive the process water, a first outlet for the demineralized whey, and a second outlet for the demineralization effluent, and
an effluent treatment system comprising:
a reverse osmosis device comprising an inlet for the demineralization effluent connected to the second outlet of the electrodialysis device, a first outlet for the reverse osmosis permeate, and a second outlet for the reverse osmosis retentate,
a neutralization device comprising a first inlet for the reverse osmosis retentate connected to the second outlet of the reverse osmosis device, a second inlet for a neutralization solution, and an outlet for the neutralized reverse osmosis retentate,
a nanofiltration device comprising an inlet for the neutralized reverse osmosis retentate connected directly to the outlet of the neutralization device or indirectly via a mechanical separation device, a first outlet for the neutralized nanofiltration retentate, and a second outlet for the nanofiltration permeate, and
a second electrodialysis device with bipolar membrane having an inlet for the nanofiltration permeate and connected to the second outlet of the nanofiltration device,
a first outlet for an acidic solution, a second outlet for a basic solution,
said system comprising recycling means comprising all or part of the following means:
a means connecting the first outlet for the reverse osmosis permeate of the reverse osmosis device with the second inlet of the first electrodialysis device intended to receive the process water, and/or
a means connecting the first outlet for an acidic solution of the second electrodialysis device with bipolar membrane with the second inlet of the first electrodialysis device, and/or
a means connecting the second outlet for a basic solution of the second electrodialysis device with bipolar membrane with the second inlet of the neutralization device and/or with the first outlet of the first electrodialysis device.
